(19) United States
(12) Patent Application Publication
(10) Pub. No.: US 2022/0314286 A1
(43) Pub. Date: Oct. 6, 2022

(54) METHOD AND DEVICE USED FOR THE SEPARATE TREATMENT OF INDIVIDUAL COMPONENTS OF PACKAGING UNITS FORMED BY PRIMARY, SECONDARY AND TERTIARY PACKAGINGS

(71) Applicant: Krones Aktiengesellschaft, Neutraubling (DE)

(72) Inventors: Tobias GUT, Unterhaching (DE); Johannes KIRZINGER, Muenchen (DE)

(21) Appl. No.: 17/432,615

(22) PCT Filed: Feb. 4, 2020
(86) PCT No.: PCT/EP2020/052720

§ 371 Date: Aug. 20, 2021

(30) Foreign Application Priority Data
Feb. 25, 2019 (DE) 10 2019 104 708.0

(51) Int. Cl. B08B 9/44; B08B 9/08; B67C 7/00; B65C 3/06

(52) U.S. Cl. CPC B08B 9/44; B08B 9/0861; B67C 7/00; B65C 3/06; B08B 2209/08

(57) ABSTRACT

Disclosed is a treatment device and/or cleaning device (10), with at least three treatment stations and/or cleaning stations (26, 36, 42), as well as a method used for the separate treatment of individual components of packaging units (14) formed in each instance by primary, secondary, and tertiary packagings.

The primary packagings are in each instance gathered together in secondary packagings as groups of two or more individual primary packagings. In addition, at least two such secondary packagings are accommodated in a tertiary packaging.

The device (10) comprises at least one separating station (16, 20, 48) used for the separation of the packaging units (14) into their individual components to be treated, as well as at least three cleaning stations (24, 34, 40) and/or inspection stations used for the separate treatment of the primary, secondary, and tertiary packagings, said cleaning stations (24, 34, 40) and/or inspection stations being arranged downstream of the at least one separating station (16, 20, 48).

The corresponding method provides the separation of the packaging units (14) into their individual components to be treated and the cleaning and/or inspection of at least the primary packagings as well as the cleaning and/or inspection of the secondary packagings performed separately therefrom and/or the cleaning and/or inspection of the tertiary packagings performed separately therefrom.

### CLAIM OF PRIORITY

The present application claims priority to International Application PCT/EP2020/052720, filed Feb. 4, 2020, which in turn claims priority to German Application DE 10 2019 104 708.0, filed Feb. 25, 2019, which are incorporated by reference.

### FIELD OF THE INVENTION

The present invention addresses a treatment device and/or cleaning device with at least three treatment stations and/or cleaning stations used for the separate treatment of individual components of packaging units formed in each instance by primary, secondary, and tertiary packagings. The present invention moreover relates to a method used for the separate treatment of individual components of packaging units formed in each instance by primary, secondary, and tertiary packagings.

### BACKGROUND OF THE INVENTION

The handling of reusable beverage containers normally involves the emptied beverage containers being returned, after the intended use of the beverage content, in the same outer packagings they were sold in. In practice, these outer packagings are usually formed by beverage crates made of plastic and open at the top and provided to accommodate a defined number of containers in an upright standing position. The container positions in such beverage crates are specified by partitions made of plastic. These partitions are formed by flat, vertical struts in the interior area of the beverage crates in such a manner that the partitions define the subdivisions that determine all individual bottle positions or container positions. A different number of containers, for example, nine, twelve, twenty, or also twenty-four containers, can be accommodated in each instance according to the size and partition division of the outer packagings or beverage crates. The containers accommodated in the beverage crates can optionally consist of a synthetic material, such as transparent PET, or of mineral glass. The accommodation of metal beverage cans is likewise conceivable in such beverage crates.

The typical reuse cycle of beverage containers and associated outer packagings as a rule provides that both the beverage crates and the empties to be recycled and to be preferably refilled with beverages are fed or returned to handling facilities and/or packaging facilities (so-called “AVT facilities”) that operate in an automated manner, where the containers or bottles are unpacked, that is, removed from the outer packagings or beverage crates, whereupon the crates are washed separately from the containers, checked, and, as a rule, fed to a packing device in order to be reloaded with filled containers.

Machines for cleaning bottle crates are known from DE 44 00 871 A1 and DE 198 49 063 C2, for example.

DE 101 16 854 B4 moreover discloses a washing system for cleaning receptacles to be transported and for the storage of beverage bottles. Cleaning fluid is applied onto the receptacles in a cleaning chamber and distributed over the crates by spray nozzles.

The handling of bottles or containers depends on the material, and it can provide either a cleaning, inspection, and refilling as well as an optional labeling of the returned (glass) containers or a material recycling of the used and returned plastic containers and the use as well as the filling and optional labeling of new containers, for example, of stretch blow molded PET containers, prior to the filled, closed, and labeled containers being placed into the cleaned beverage crates, which can then be completed and palletized and/or otherwise packaged and supplied to the trade.

The recycling process is thus completed based on the multiple use of the containers and of the outer packagings accommodating a defined number of containers.

However, since not only the container shapes and the materials used for this purpose, but also the packagings shapes and packaging variants are becoming more and more diverse and variable, there are no tried and tested handling methods available in the reuse process for some of these novel packagings variants. Disadvantages from this arise, for example, when not only individual bottles are placed into the crates, but also additional outer packagings with bottles located therein. Of the known six-packs (that is to say, groups of six bottles), for example, typically four can be placed into a beverage crate. Such additional outer packagings are currently not readily reusable and expediently handleable in the reuse process, in particular because there are no tried and tested cleaning processes and recycling processes available yet for reusable outer packagings that are placed into crates.

In view of the deficiencies and disadvantages identified in the prior art, the primary object of the present invention can be seen in providing an integrated treatment facility and/or cleaning facility as well as a corresponding method, which make it possible to reliably handle complex packaging units and to clean them with satisfactory results.

This object of the invention is achieved by the subject matter having the features of the independent claims. Further advantageous embodiments are described in the dependent claims.

### SUMMARY OF THE INVENTION

In order to achieve the above-mentioned object, the present invention proposes a treatment device and/or cleaning device to be used for packagings and for individual components of more complex packaging units, the treatment device and/or cleaning device having the features of the independent claims, and being provided with at least three treatment stations and/or cleaning stations used for the separate treatment of a plurality of components of packaging units.

The at least three treatment stations and/or cleaning stations are in particular provided and equipped for the treatment and/or cleaning of a multitude of individual components of packaging units formed in each instance by primary, secondary, and tertiary packagings, the components being conveyed through the stations.

The facility referred to in this context as treatment device and/or cleaning device can in particular be a more complex facility with a plurality of individual facility modules. The individual facility modules can be lined up immediately one after another, for example, or also be connected to each other in terms of conveyor technology via transport sections. The packaging units and their components are conveyed through the facility and between the individual facility modules in particular by suitable transport devices formed, for example, by horizontal conveyors.

In this context, it is provided that the primary packagings formed in particular by liquid containers, bottles, cans, or the like of the same type are in each instance gathered together as groups of two or more individual primary packagings in secondary packagings. Primary packagings in this sense are thus intended to be understood as all units or individual articles that are normally packaged and/or transported and handled in a grouped manner and that in turn accommodate, in particular in a manner that is closed to the outside, packaging items or fillings in a liquid, pasty, solid, granular, or other state.

The accommodating and/or wrapping fittings for the primary packagings, which fittings are referred to in this context as secondary packagings, can be formed, for example, by caskets, crates, so-called baskets, carriers, or the like, that are capable of accommodating a defined number of primary packagings. The term “accommodating” in the present context is primarily intended to imply a loose but orderly accommodating; this is however not to be understood in a restrictive sense. It is likewise possible for secondary packagings to firmly enclose and/or cover two or more primary packagings, for example by a packaging material such as film or paper wrapping the secondary packagings together.

It is in addition provided that at least two such secondary packagings are accommodated in each instance in a tertiary packaging. The tertiary packagings, in turn, can also be of different types and shapes, and can be formed, for example, by crates that are open at the top, by boxes, or by other packaging types. It is likewise possible for tertiary packagings to firmly enclose and/or cover two or more secondary packagings, for example by a packaging material such as film or paper to wrap the secondary packagings together.

That is to say that the names for the packagings were as a rule selected in this context in such a manner that the actual packaging items, which are usually formed by a liquid or by a beverage, are accommodated in the primary packagings, while these primary packagings are accommodated and gathered together pairwise or groupwise in so-called secondary packagings or outer packagings.

These secondary packagings or outer packagings, which can consist, for example, of a synthetic material or of cardboard or also of a composite material, are in turn accommodated in tertiary packagings and, to be specific, again pairwise or groupwise. It is thus possible that in each instance six primary packagings are gathered together by secondary packagings in so-called six-packs, for example. If four such secondary packagings formed by six-packs of six primary packagings each are placed in a tertiary packaging, the tertiary packaging accommodates a total of twenty-four primary packagings.

Although it is also possible to accommodate these twenty-four primary packagings directly without the additional use of secondary packagings in a beverage crate or the like, there are many types of packaging sets for which it is desirable to use additional reusable outer packagings in order to thus make smaller packaging units available without having to handle them each individually. By accommodating the secondary packagings in larger tertiary packagings, it is possible to maintain the familiar packaging and bundle handling and to simultaneously create an additional breakdown into smaller bundle units that can offer more convenience to the end customers.

The treatment device and/or cleaning device according to the invention comprises at least one separating station that is used for the separation of the packaging units into their individual components to be treated as well as comprising at least three cleaning stations and/or inspection stations that are used for the separate treatment of the primary, secondary, and tertiary packagings, the cleaning stations and/or inspection stations being arranged downstream of the at least one separating station.

All of the primary, secondary, and tertiary packagings treated with the presently described treatment device and/or cleaning device are normally configured for reuse handling and are therefore cleaned or otherwise treated and reassembled for a refill, for a bundle assembly and/or for packaging.

However, the treatment device and/or cleaning device according to the invention is by no means limited to the handling of purely reusable packagings and reusable packaging units. If a treatment of the primary packagings, of the secondary, and/or of the tertiary packagings is referred to, these terms can in the individual case also comprise the replacement of used-up, worn-out, and/or damaged primary, secondary, and/or tertiary packagings if such a replacement has been identified as expedient after the inspection of the individual parts passing through the device. In modification of this principle, the device can also be made capable of replacing such primary, secondary, or tertiary packagings by new ones if the primary, secondary, or tertiary packagings were not intended for reuse or multiple use at all, for example, because they are more readily subject to wear and tear than other packaging components or because they should rather be considered as one-way packaging types.

The separating station and the different possible embodiments thereof are explained below.

The treatment device and/or cleaning device according to the invention, with its at least three treatment stations and/or cleaning stations that are used for the separate treatment of the individual components of the mentioned packaging units can have, for example, a first separating station that is used for the removal of the secondary packagings from the particular tertiary packagings, and it can also have a second separating station that is used for the removal of the primary packagings from the secondary packagings, the second separating station being arranged downstream of the first separating station. In this embodiment variant of the device, the tertiary and secondary packagings are thus separated from each other first, while the primary packagings can optionally still remain unvaryingly in the secondary packagings in order to be removed from there in a subsequent separation step. For this purpose, it is in particular possible to provide a third separating station that is used for the removal of the primary packagings from the secondary packagings that have already been removed from the particular tertiary packagings.

If separating stations are referred to in the present context, these as a rule comprise suitable handling apparatuses or manipulators used for lifting the secondary packagings out of the tertiary packagings, for example. The separating station referred to in this context as third separating station and serving for the removal of the primary packagings from the secondary packagings can comprise a gripper head, for example, with a plurality of bottle grippers formed by suction grippers, for example, used for receiving the bottles at their particular head sections, which gripper head can simultaneously seize and lift out all articles or bottles referred to in this context as primary packagings that are located in the secondary packaging.

An alternative embodiment variant of the device according to the invention can provide that both a third separating station that is used for the removal of the primary packagings from the secondary packagings still located in the particular tertiary packagings and a first separating station that is used for the removal of the secondary packagings from the tertiary packagings are provided, with the first separating station being arranged downstream of the third separating station.

Another alternative device variant can have a fourth separating station, which can serve for the simultaneous or approximately simultaneous removal of the secondary packagings from the particular tertiary packagings and which can also serve for the removal of the primary packagings from the particular secondary packagings.

Furthermore, at least one inspection station can be provided for the device according to the invention, the inspection station being used for the optical check of the primary packagings and/or of the secondary packagings and/or of the tertiary packagings for existing damages, dirt, color blemishes or other optical blemishes, and/or for the presence of foreign particles. An expedient configuration variant in this context can provide a plurality of inspection stations, in particular in each of the present treatment sections and/or cleaning sections, that is to say, both for the primary packagings that have been separated from the secondary packagings and for the secondary packagings that have been taken out of the tertiary packagings and freed from the primary packagings and moreover, for the tertiary packagings that have been freed from the secondary packagings.

An expedient configuration can provide the inspection devices to be in each instance arranged downstream of the above-mentioned separating stations as seen in conveying direction of the packaging components, and, more specifically, to be arranged in the upstream segments of the particular treatment sections and/or cleaning sections, because it is usually more expedient to first inspect the primary, secondary, or tertiary packagings to be treated and/or to be cleaned before deciding whether the particular packaging needs to be further treated or cleaned, since it is not necessary to first clean or treat a damaged or very dirty or in another way unusable primary, secondary, or tertiary packaging and to subsequently discharge it for not being reusable.

If at least one such inspection device is present, or if a plurality of such inspection devices are present the data acquired in such a way on the state of the primary, secondary, and/or tertiary packagings can be used in an advantageous manner to take packagings out of the further treatment process that are too dirty, damaged, or identified as defective in another manner, for example, by at least one controllable discharge station that is used for the discharge or diversion of primary, secondary, and/or tertiary packagings from the ongoing conveyance process and/or treatment process if the primary, secondary, and/or tertiary packagings are defective or have been identified and/or designated as defective by the inspection station, the discharge station being arranged downstream of the at least one inspection station.

If at least one such discharge station is present, it can be expedient to perform the discharges in each instance in transport direction before the further treatment or cleaning of the particular primary, secondary, or tertiary packagings, because such redundant cleaning steps or treatment steps can then be dispensed with for primary, secondary, or tertiary packagings that are no longer recyclable.

In a corresponding manner, if a plurality of such inspection devices are present, the data acquired in such a way on the state of the primary, secondary, and/or tertiary packagings can be used in an advantageous manner to take packagings out of the further treatment process that are too dirty, damaged, or identified as defective in another manner, specifically, by the plurality of controllable discharge stations that are used for the discharge or diversion of primary, secondary, and/or tertiary packagings from the particular ongoing conveyance processes and/or treatment processes for the individual packaging types if the primary, secondary, and/or tertiary packagings are defective or have been identified and/or designated as defective by the particular inspection stations, the discharge stations being in each instance arranged downstream of the inspection stations.

In addition, if a plurality of such inspection devices are present, the data acquired in such a way on the state of the primary, secondary, and/or tertiary packagings can be used in an advantageous manner to support a quality assurance system, because after evaluation of a multitude of data, sudden deviations from a normally measured reject rate can provide indication of upstream quality problems in the production or handling of the primary and/or secondary and/or tertiary packagings.

In an expedient device variant, a filling station can furthermore be provided that is used to fill the cleaned and inspected primary packagings with an intended packaging content, in particular with a liquid or a beverage, and a first handling station can also be provided that is used to groupwise insert the filled primary packagings into cleaned and/or inspected secondary packagings in each instance assigned to the primary packagings and/or to cover the primary packagings with the secondary packagings, the first handling station being arranged downstream of the filling station. In this context, an option of the device can be equipped in such a manner that the secondary packagings to be loaded or to be filled with primary packagings are already located in a tertiary packaging, and they are treated and the packaging units are completed in this prepared state of packaging.

Moreover, a second handling station can be assigned to or arranged downstream of the mentioned first handling station, the second handling station being used to groupwise insert at least two secondary packagings containing in each instance a group of primary packagings filled with packaging items and/or with liquid into a cleaned and/or inspected tertiary packaging, or to assemble the secondary packagings together with such a cleaned and/or inspected tertiary packaging. While it is normally provided that the secondary packagings and the primary packagings located therein are of the same type, in particular identical, each tertiary packaging can also optionally in each instance accommodate at least two different secondary packagings or secondary packagings with in each instance different primary packagings located therein. The device according to the invention is thus not only suitable for the handling of in each instance same packaging components, but can also handle different bundles or bundles with in each instance different primary and/or secondary packagings without any problems.

Another equipment option of the device according to the invention can comprise at least one drying station that is used for the freeing of the primary packagings and/or of the secondary packagings and/or of the tertiary packagings from adhering cleaning fluid after in each instance having undergone the cleaning process. This is particularly necessary if the primary, secondary, or tertiary packagings are intended to be printed on, labeled, or provided with other equipment elements, because dry and clean surfaces are required for the reliable adhesion of labels or of other equipment elements or in order to achieve a perfect printing result.

In addition, a microfilter station at least for the cleaning fluid used for the cleaning of the primary packagings can be present in the device according to the invention, which microfilter station retains suspended solids and particles, in particular plastics, such as microplastic particles, and filters them out of the cleaning fluid. Another option can in this context provide an ultrafiltration or reverse osmosis or the like, so that the cleaning fluid used for the primary packagings can undergo an optimal cleaning for a multiple use.

At suitable points, the cleaning device and/or treatment device according to the invention can moreover comprise labeling stations and/or printing stations that are used to code, label, and/or print onto the secondary packagings and/or tertiary packagings after cleaning or inspection has been performed. The device can likewise comprise at least one further labeling station and/or printing station that is used to code, label, and/or print onto the primary packagings after cleaning or inspection has been performed and/or after refill with packaging items or with liquid.

The present invention is particularly suitable for the handling of relatively novel bundles comprising reusable secondary packagings, for example, in the form of so-called plastic baskets. In order to be able to process such secondary packagings or so-called plastic baskets in the facility, further process steps need to be included. These process steps comprise the above-described separating of the bundles into their individual components, the subsequent inspection of the individual components or at least of the primary packagings the cleaning stations or the so-called bundle washers a sorting unit if there are different types of bundles, and an optional pack buffer in order to be able to flexibly handle different treatment speeds or variably discharged packagings.

Further options can lie therein that adhering labels or prints are washed off as required, whereupon the packagings are preferably subsequently dried so that they can be fed to a new printing or labeling process. Apart from the already mentioned filtering of the washing water to prevent in particular microplastic parts from entering into the process water of the facility, in particular of the bottle washer, it is moreover optionally possible to carry out a bundle coding that can be read out mechanically or also by an operator, if required, the bundle coding being carried out, for example, by a suitable printing with a barcode or with another suitable coding variant.

The advantages of the invention lie particularly therein that it enables a processing of novel bundle types, thereby potentially improving sustainability at the same time.

In order to achieve the above-mentioned object and in addition to the device explained in different embodiment variants above, the invention furthermore proposes a method used for the separate treatment of a multitude of individual components of packaging units formed in each instance by primary, secondary, and tertiary packagings, the method having the features of the independent method claim. As already explained above for the device, it is also provided in the method according to the invention that the primary packagings formed in particular by liquid containers, bottles, cans, or the like of the same type are in each instance gathered together as groups of two or more individual primary packagings in secondary packagings. In addition, at least two such secondary packagings are accommodated in a tertiary packaging. Central to the method according to the invention is the aspect of the separation of the packaging units into their individual components to be treated as well as the cleaning and/or inspection of at least the primary packagings as well as the cleaning and/or inspection of the secondary packagings performed separately therefrom and/or the cleaning and/or inspection of the tertiary packagings performed separately therefrom.

It can be optionally provided in the method that the secondary packagings are taken out of or separated from the particular tertiary packagings prior to the cleaning and/or inspection of the secondary packagings, whereupon the primary packagings are subsequently taken out of or separated from the secondary packagings prior to the cleaning and/or inspection of the primary packagings, with the primary, secondary, and tertiary packagings in each instance also being cleaned and/or inspected separately from one another.

As an alternative, the method can also provide that the primary packagings are taken out of or separated from the secondary packagings prior to the cleaning and/or inspection of the primary packagings with the secondary packagings still located in the particular tertiary packagings, while the secondary packagings are subsequently taken out of or separated from the tertiary packagings prior to the cleaning and/or inspection of the secondary packagings, with the primary, secondary, and tertiary packagings in each instance being cleaned and/or inspected separately from one another.

Another alternative embodiment variant of the method according to the invention can provide that the secondary packagings to be removed from the particular tertiary packagings are separated from the primary packagings located therein or the primary packagings are taken out of the secondary packagings during the removal of the secondary packagings from the tertiary packagings and/or during the transfer of the secondary packagings to a subsequent cleaning step and/or inspection step.

In addition, an inspection of the primary packagings and/or of the secondary packagings and/or of the tertiary packagings can be carried out, with such an inspection preferably comprising in each instance at least an optical check for existing damages, dirt, color blemishes or other optical blemishes, and/or for the presence of foreign particles.

After such an inspection, it is moreover possible to decide on an expedient discharge of packagings that have been identified as imperfect so that an expedient method variant can provide that a controllable and need-based discharge or diversion from the ongoing conveyance process and/or treatment process of primary, secondary, and/or tertiary packagings that are defective or that have been designated as defective is arranged downstream of the inspection of the primary and/or secondary and/or tertiary packagings.

The primary packagings can optionally be refilled with their intended packaging content, in particular with a liquid or a beverage, after cleaning and/or inspection has been performed, whereupon the primary packagings can be inserted groupwise into or covered with a cleaned and/or inspected secondary packaging.

In addition, at least two secondary packagings containing in each instance a group of primary packagings filled with packaging items and/or with liquid can be assembled together with or inserted into a cleaned and/or inspected tertiary packaging.

In this method, either all tertiary packagings can be configured in the same manner and in each instance loaded with identical secondary packagings. Optionally, however, the tertiary packagings can also in each instance accommodate different secondary packagings or secondary packagings with in each instance different primary packagings located therein.

The method can moreover provide that the primary packagings and/or the secondary packagings and/or the tertiary packagings pass through a drying station after in each instance having undergone the cleaning process, in which drying station the packagings are freed from adhering cleaning fluid.

In another advantageous method variant, at least the cleaning fluid used for the cleaning of the primary packagings can pass through a microfilter, which retains suspended solids and particles, in particular plastics, such as microplastic particles, and filters them out of the cleaning fluid. Likewise conceivable is a so-called ultrafiltration or a reverse osmosis or the like in order to achieve an optimal cleaning for the preferably multiple reusable cleaning fluid.

After cleaning or inspection has been performed and/or after reloading, the secondary and/or tertiary packagings can be coded, labeled, and/or printed onto on their exteriors or shell surfaces, if required.

In addition, the primary packagings can be coded, labeled, and/or printed onto, if required, after cleaning or inspection has been performed and/or after refill with packaging items or with liquid.

It should be explicitly mentioned at this point that all aspects and embodiment variants explained in the context of the treatment device and/or cleaning device according to the invention can likewise pertain to or constitute partial aspects of the method according to the invention used for the separate treatment of individual components of packaging units that are formed in each instance by primary, secondary, and tertiary packagings. If specific aspects and/or interrelations and/or effects relating to the device according to the invention are referred to at some point in the present description or in the claims definitions, this therefore likewise pertains to the method according to the invention.

The same applies conversely, so that all aspects and embodiment variants explained in the context of the method according to the invention can likewise pertain to or constitute partial aspects of the device according to the invention. If specific aspects and/or interrelations and/or effects relating to the method according to the invention are referred to at some point in the present description or in the claims definitions, this therefore likewise pertains to the device according to the invention.

### BRIEF DESCRIPTION OF THE FIGURES

In the following passages, the attached figures further illustrate typical embodiments of the invention and their advantages. The size ratios of the individual elements in the figures do not necessarily reflect the real size ratios. It is to be understood that in some instances various aspects of the invention may be shown exaggerated or enlarged in relation to other elements to facilitate an understanding of the invention.

FIG. 1 shows a first embodiment variant of a treatment device and/or cleaning device designed according to the invention for packagings and for individual components of more complex packaging units in a schematic flow chart on the basis of function symbols that are related to each other.

FIG. 2 shows a second embodiment variant of the treatment device and/or cleaning device according to the invention in a further schematic flow chart.

FIG. 3 shows a third embodiment variant of the treatment device and/or cleaning device according to the invention in a third schematic flow chart.

The same or equivalent elements of the invention are designated using identical reference characters. Furthermore and for the sake of clarity, only the reference characters relevant for describing the individual figures are provided. It should be understood that the detailed description and specific examples of the embodiments of the apparatus or of the method according to the invention are intended for purposes of illustration only and are not intended to limit the scope of the invention.

### DETAILED DESCRIPTION OF THE INVENTION

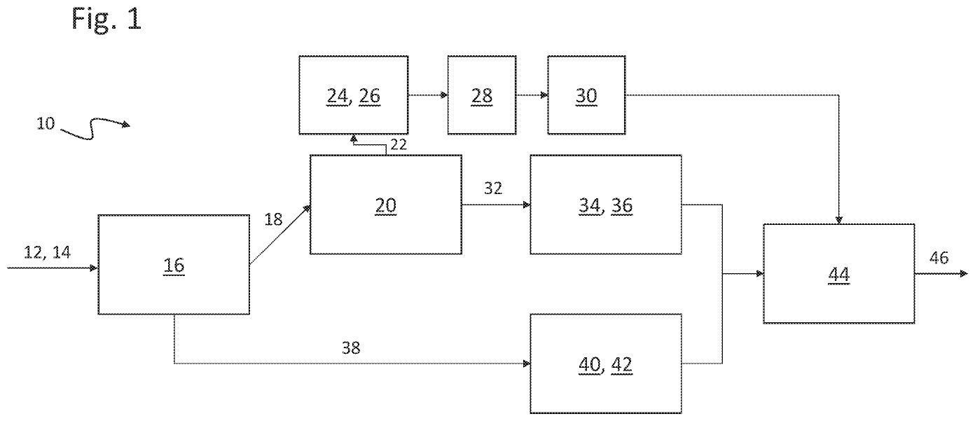

On the basis of function symbols that are related to each other, the schematic flow chart in FIG. 1 shows a first embodiment variant of a treatment device and/or cleaning device 10 designed according to the invention for packagings and for individual components of more complex packaging units 14. A product stream 12 of more complex packaging units 14 is directed to the device 10, where the packaging units 14 are separated into their individual components—which will be explained in more detail below—in order for these individual components to be treated separately from one another.

In the first variant of the cleaning device and/or treatment device 10 shown in FIG. 1, the product stream 12 with the packaging units 14 still complete leads into a first separating station 16, where the two or more secondary packagings are taken out of the particular tertiary packagings first. The first separating station 16 can in this context also be referred to as first unpacker, where the secondary packagings that are still filled with the primary packagings are removed or unpacked from the tertiary packagings. Arranged downstream of the first separating station 16 as seen in conveying direction 18 of the secondary packagings that have been removed from the tertiary packagings is a second separating station 20, in which the primary packagings are removed from the particular secondary packagings. The second separating station 20 can in this context also be referred to as second unpacker, where the primary packagings that are still located in the secondary primary packagings are removed or unpacked from the secondary packagings.

The primary packagings taken out of the secondary packagings in the second separating station 20 are fed in conveying direction 22 of the primary packagings to be cleaned to a first cleaning station 24, which in this context can be formed by a bottle washer 26, for example, in particular if the primary packagings take the form of reusable bottles or reusable liquid containers. The bottles or primary packagings cleaned in such a way can subsequently be refilled in a filling station 28 with a liquid or a beverage, whereupon the filled bottles or primary packagings can be provided in a labeling station 30 arranged downstream with appropriate new labels.

In addition, the secondary packagings that have been freed from the primary packagings in the second separating station 20 are fed in conveying direction 32 of the secondary packagings to be cleaned to a second cleaning station 34, which in this context is formed by a so-called bundle washer 36. Since the secondary packagings are formed in the described exemplary embodiment by reusable outer packagings for the purpose of forming smaller bundle units, the second cleaning station 34 is consequently referred to as bundle washer 36.

FIG. 1 furthermore illustrates that the tertiary packagings that are freed in the first separating station 16 from the secondary packagings with the primary packagings still located therein are fed in conveying direction 38 of the tertiary packagings to be cleaned to a third cleaning station 40, which in this context is formed by a so-called crate washer 42. Since the tertiary packagings are formed in the described exemplary embodiment in particular by larger reusable outer packagings, for example by beverage crates or the like, which are capable of accommodating a plurality of secondary packagings or of smaller reusable outer packagings, the third cleaning station 40 can consequently be referred to as crate washer 42.

In a packer 44 arranged downstream of the labeling station 30, of the second cleaning station 34, as well as of the third cleaning station 40, the product streams can be joined again by inserting the cleaned, filled, and labeled containers, bottles, or primary packagings into the secondary packagings or reusable outer packagings cleaned by the bundle washer 36, and the secondary packagings or reusable outer packagings can in turn be inserted into the tertiary packagings or beverage crates cleaned by the crate washer 42. Arranged downstream of the packer 44, there can be further packaging stations and/or palletizing stations 46 or the like, in which larger packaging units can be formed and made ready for shipping.

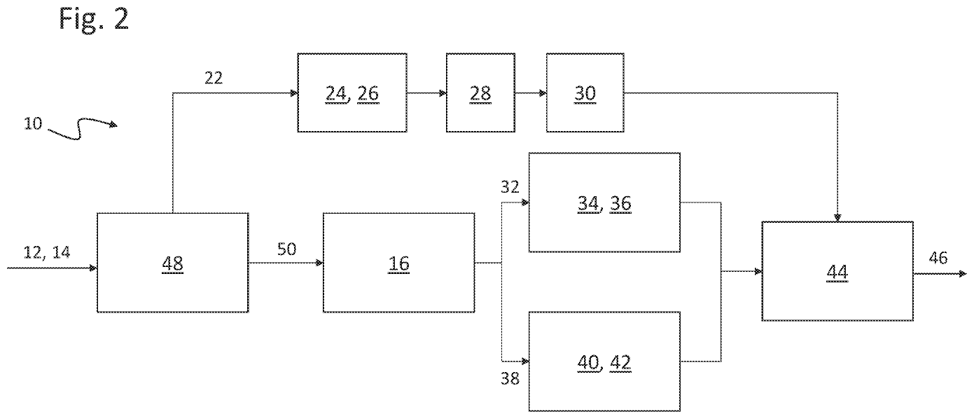

On the basis of function symbols that are related to each other, the schematic flow chart in FIG. 2 shows a second embodiment variant of a treatment device and/or cleaning device 10 designed according to the invention for packagings and for individual components of more complex packaging units 14. As in the first variant, a product stream 12 of more complex packaging units 14 is directed to the device 10, where the packaging units 14 are separated into their individual components in order for the individual components to be treated separately from one another.

In the second variant of the cleaning device and/or treatment device 10 shown in FIG. 2, the product stream 12 with the packaging units 14 still complete leads into an unpacker first, which for reasons of systematic naming and for the purpose of differentiation from the first and second separating stations referred to in the first embodiment variant according to FIG. 1 is in this context referred to as third separating station 48. With the aid of this third separating station 48, the primary packagings formed, for example, by bottles or beverage containers, are taken out of the secondary packagings that are still located in the tertiary packagings first. Arranged downstream of the third separating station 48 as seen in conveying direction 50 of the tertiary packagings that are still loaded with the emptied secondary packagings is a first separating station 16, in which the secondary packagings that have already been freed from the primary packagings by the third separating station 48 are removed from the tertiary packagings.

The primary packagings taken out of the secondary packagings still located in the tertiary packagings in the third separating station 48 are fed in conveying direction 22 of the primary packagings to be cleaned to a first cleaning station 24, which in this context is formed by a bottle washer 26, as the primary packagings in the exemplary embodiment described in this context and illustrated in FIG. 2 are reusable bottles or reusable liquid containers. The bottles or primary packagings cleaned in such a way can subsequently be refilled in the filling station 28 arranged downstream with a liquid or a beverage, whereupon the filled bottles or primary packagings can be provided in the labeling station 30 arranged downstream with appropriate new labels.

In addition, the tertiary packagings that have been freed from the secondary packagings in the first separating station 16 are fed in conveying direction 32 of the secondary packagings to be cleaned to a second cleaning station 34, which in this context is again formed by a bundle washer 36.

FIG. 2 moreover illustrates that the tertiary packagings freed in the first separating station 16 from the secondary packagings with the primary packagings previously removed therefrom are fed in conveying direction 38 of the tertiary packagings to be cleaned to a third cleaning station 40, which in this context is again formed by a crate washer 42.

In the packer 44 arranged downstream of the labeling station 30, of the second cleaning station 34, as well as of the third cleaning station 40, the product streams are joined again by inserting the cleaned, filled, and labeled containers, bottles, or primary packagings into the secondary packagings or reusable outer packagings cleaned by the bundle washer 36, and the secondary packagings or reusable outer packagings are in turn inserted into the tertiary packagings or beverage crates cleaned by the crate washer 42. Arranged downstream of the packer 44, there can be further packaging stations and/or palletizing stations 46 or the like, in which larger packaging units can be formed and made ready for shipping.

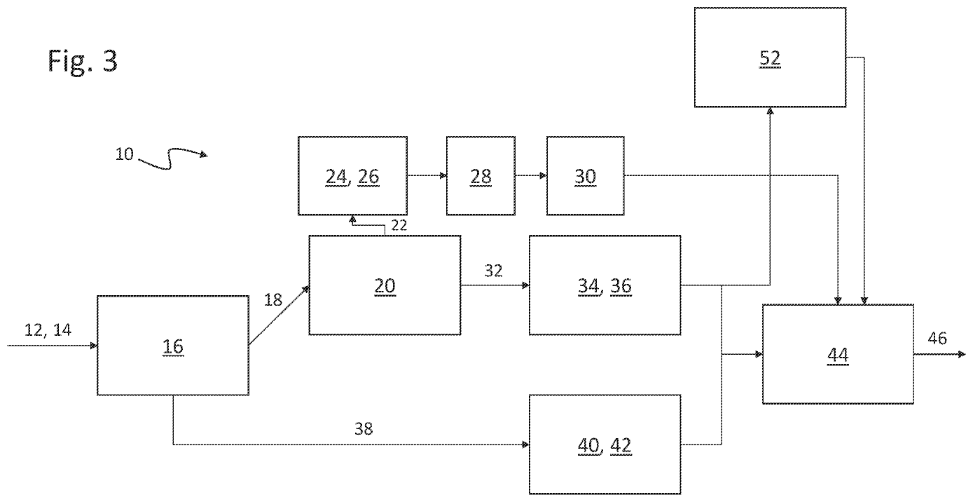

The further schematic flow chart in FIG. 3 largely corresponds to the first variant shown in FIG. 1, with FIG. 3 showing a third embodiment variant of a treatment device and/or cleaning device 10 designed according to the invention for packagings and for individual components of more complex packaging units 14, the third embodiment variant being enhanced in relation to the first variant. A product stream 12 of more complex packaging units 14 is directed to the device 10, where the packaging units 14 are separated into their individual components—which will be explained in more detail below—in order for these individual components to be treated separately from one another.

In the third variant of the cleaning device and/or treatment device 10 shown in FIG. 3, the product stream 12 with the packaging units 14 still complete leads into a first separating station 16, where the two or more secondary packagings are taken out of the particular tertiary packagings first. Arranged downstream of the first separating station 16 as seen in conveying direction 18 of the secondary packagings that have been removed from the tertiary packagings is a second separating station 20, in which the primary packagings are removed from the particular secondary packagings.

The primary packagings taken out of the secondary packagings in the second separating station 20 are fed in conveying direction 22 of the primary packagings to be cleaned to a first cleaning station 24, which in this context is again formed by the bottle washer 26. The bottles or primary packagings cleaned there are refilled in the filling station 28 arranged downstream with a liquid or a beverage, whereupon the filled bottles or primary packagings are provided in the labeling station 30 arranged downstream with appropriate new labels.

As is discernible in FIG. 3, the secondary packagings that have been freed from the primary packagings in the second separating station 20 are fed in conveying direction 32 of the secondary packagings to be cleaned to the second cleaning station 34, which in this context is again formed by the bundle washer 36. Moreover, the tertiary packagings that have been freed in the first separating station 16 from the secondary packagings with the primary packagings still located therein are fed in conveying direction 38 of the tertiary packagings to be cleaned to a third cleaning station 40, which in this context is formed by the crate washer 42.

Following the second cleaning station 34 formed by the bundle washer 36, there can be a buffer station 52 for the secondary packagings, where individual or also a greater number of cleaned secondary packagings or reusable bundle packagings can be intermediately stored, in order for the packer 44 arranged downstream to have a sufficient number of secondary packagings available under any circumstances, even if there are temporary blockages in the second cleaning station 34. Like the second cleaning station 34 and the third cleaning station 40, the variably and on an as-needed basis usable buffer station 52 leads into the packer 44 arranged downstream, where the product streams are joined again by inserting the cleaned, filled, and labeled containers, bottles, or primary packagings into the secondary packagings or reusable outer packagings cleaned by the bundle washer 36 and intermediately stored in the buffer station 52, and the secondary packagings or reusable outer packagings are in turn inserted into the tertiary packagings or beverage crates cleaned by the crate washer 42. Arranged downstream of the packer 44, there can be further packaging stations and/or palletizing stations 46 or the like, in which larger packaging units can be formed and made ready for shipping.

If first, second, and third separating stations 16, 20, 48 are referred to in the above context, these as a rule comprise suitable handling apparatuses or manipulators used for lifting the secondary packagings out of the tertiary packagings, for example, which is, however, not shown in detail here in the schematic illustrations of the FIGS. 1 to 3. The separating station referred to in this context as third separating station 48 and serving for the removal of the primary packagings from the secondary packagings can comprise a gripper head, for example, with a plurality of bottle grippers formed by suction grippers, for example, used for receiving the bottles at their particular head sections, which gripper head can simultaneously seize and lift out all articles or bottles referred to in this context as primary packagings that are located in the secondary packaging.

Also not shown in the schematic illustrations of the FIGS. 1 to 3 and preferentially to be used in the device 10 according to the invention are inspection stations provided for the optical check of the primary packagings and/or of the secondary packagings and/or of the tertiary packagings for existing damages, dirt, color blemishes or other optical blemishes, and/or for the presence of foreign particles or the like. An expedient configuration variant in this context can provide a plurality of inspection stations, in particular in each of the present treatment sections and/or cleaning sections, that is to say, for the primary packagings that have been separated from the secondary packagings and also for the secondary packagings that have been taken out of the tertiary packagings and freed from the primary packagings and, moreover, for the tertiary packagings that have been freed from the secondary packagings.

An expedient configuration can provide the inspection devices (not shown here) to be in each instance arranged downstream of the above-mentioned separating stations 16, 20, 48 as seen in conveying direction of the packaging components, and, more specifically, to be arranged in the upstream segments of the particular treatment sections and/or cleaning sections, because it is usually more expedient to first inspect the primary, secondary, or tertiary packagings to be treated and/or to be cleaned before deciding whether the particular packaging needs to be further treated or cleaned, since it is not necessary to first clean or treat a damaged or very dirty or in another way unusable primary, secondary, or tertiary packaging and to subsequently discharge it for not being reusable.

If at least one such inspection device is present, or if a plurality of such inspection devices are present the data thus acquired on the state of the primary, secondary, and/or tertiary packagings can be used in an advantageous manner to take packagings out of the further treatment process that are too dirty, damaged, or identified as defective in another manner, for example, by at least one controllable discharge station (also not shown here) that is used for the discharge or diversion of primary, secondary, and/or tertiary packagings from the ongoing conveyance process and/or treatment process if the primary, secondary, and/or tertiary packagings are defective or have been identified and/or designated as defective by the inspection station, the discharge station being arranged downstream of the at least one inspection station. If at least one such discharge station is present, it can be expedient to perform the discharges in each instance in transport direction before the further treatment or cleaning of the particular primary, secondary, or tertiary packagings, because such redundant cleaning steps or treatment steps can then be dispensed with for primary, secondary, or tertiary packagings that are no longer recyclable.

The following notes additionally refer to the above explanations. If the embodiment variants shown in the illustrations and aspects thereof are generally referred to in the context of the figures and the above descriptions as being “schematic”, this is by no means intended to imply that the illustration of the figures and their description are of inferior significance with regard to the disclosure of the invention. The person skilled in the art is fully capable of gathering sufficient information from the schematically and abstractly drawn illustrations for facilitating the understanding of the invention. On the basis of the figures offering more concrete explanations of the realizations of the method according to the invention and more concrete explanations of the structure of the apparatus according to the invention, the person skilled in the art is, as reader, enabled to derive a better understanding of the inventive idea, which is formulated in a more general and/or more abstract manner in the claims and in the general part of the description.

The invention has been described with reference to a preferred embodiment. Those skilled in the art will appreciate that numerous changes and modifications can be made to the preferred embodiments of the invention and that such changes and modifications can be made without departing from the spirit of the invention. It is therefore intended that the appended claims cover all such equivalent variations as fall within the true spirit and scope of the invention.

### LIST OF REFERENCE CHARACTERS

10 Device, treatment device, cleaning device, treatment device and/or cleaning device
12 Product stream
14 Packaging units, complex packaging units
16 First separating station, first unpacker
18 Conveying direction of the secondary packagings, conveying direction of the secondary packagings containing the primary packagings
20 Second separating station, second unpacker
22 Conveying direction of the primary packagings, conveying direction of the primary packagings to be cleaned
24 First cleaning station
26 Bottle washer
28 Filling station
30 Labeling station
32 Conveying direction of the secondary packagings, conveying direction of the secondary packagings to be cleaned
34 Second cleaning station
36 Bundle washer
38 Conveying direction of the tertiary packagings, conveying direction of the tertiary packagings to be cleaned
40 Third cleaning station
42 Crate washer
44 Packer
46 Packaging station, palletizing station, further packaging stations and/or palletizing stations
48 Third separating station
50 Conveying direction of the tertiary packagings, conveying direction of the tertiary packagings to be freed from secondary packagings
52 Buffer station

1. A device (10), comprising:
at least one separating station (16, 20, 48) used for the separation of packaging units (14) into their individual components to be treated, wherein the packaging units (14) are formed of primary, secondary, and tertiary packagings, wherein the primary packagings are containers of the same type that are gathered together as groups of two or more individual primary packagings in secondary packagings, and wherein at least two such secondary packagings are accommodated in a tertiary packaging, and
at least three cleaning stations (24, 34, 40) or inspection stations used for the separate treatment of the primary, secondary, and tertiary packagings, the cleaning stations (24, 34, 40) or inspection stations being arranged downstream of the at least one separating station (16, 20, 48).

2. The device of claim 1, comprising a first separating station (16) for the removal of the secondary packagings from the tertiary packagings, and comprising a second separating station (20) for the removal of the primary packagings from the secondary packagings, with the second separating station (20) being arranged downstream of the first separating station (16).

3. The device of claim 1, comprising a third separating station (48) for the removal of the primary packagings from the secondary packagings still located in the tertiary packagings, and comprising a first separating station (16) for the removal of the secondary packagings from the tertiary packagings, with the first separating station (16) being arranged downstream of the third separating station (48).

4. The device of claim 1, comprising a fourth separating station for the simultaneous, or approximately simultaneous, removal of the secondary packagings from the tertiary packagings and for the removal of the primary packagings from the secondary packagings.

5. The device of claim 1, comprising at least one inspection station for the optical checking of the primary packagings or of the secondary packagings or of the tertiary packagings for existing damages, dirt, color blemishes, other optical blemishes, or for the presence of foreign particles.

6. The device of claim 5, further comprising at least one controllable discharge station for the discharge or diversion of primary, secondary, or tertiary packagings if the primary, secondary, or tertiary packagings that have been designated as defective by the inspection station, with the discharge station being arranged downstream of the at least one inspection station.

7. The device of claim 1, further comprising a filling station (28) for the filling of the cleaned and inspected primary packagings and further comprising a first handling station (44) for the groupwise insertion of the filled primary packagings into cleaned or inspected secondary packagings or for the covering of the primary packagings with the secondary packagings, with the first handling station (44) being arranged downstream of the filling station (28).

8. The device of claim 7, further comprising a second handling station assigned to, or arranged downstream of the first handling station (44), the second handling station being for the groupwise insertion of at least two secondary packagings containing a group of filled primary packagings into a cleaned or inspected tertiary packaging, or the second handling station being for the assembly of the secondary packagings together with such a cleaned or inspected tertiary packaging.

9. The device of claim 1, further comprising at least one drying station for drying the primary packagings or of the secondary packagings or of the tertiary packagings after treatment.

10. The device of claim 1 further comprising a microfilter station at least for cleaning fluid used for the cleaning of the primary packagings, wherein the microfilter station retains suspended solids and particles and filters them out of the cleaning fluid.

11. The device of claim 1 further comprising at least one labeling station or printing station to label or print onto the secondary packagings or tertiary packagings after treatment.

12. The device of claim 11, further comprising at least one further labeling station or printing station (30) to label or print onto the primary packagings after treatment or after refill.

13. A method comprising:
separating packaging units (14) into their individual components, wherein the packaging units (14) are formed of primary, secondary, and tertiary packagings, wherein the primary packagings are containers of the same type that are gathered together as groups of two or more individual primary packagings in secondary packagings, and wherein at least two such secondary packagings are accommodated in a tertiary packaging, and
cleaning or inspecting at least the primary packagings and cleaning or inspecting the secondary packagings performed separately therefrom or cleaning or inspecting the tertiary packagings performed separately therefrom.

14. The method of claim 13, comprising separating the secondary packagings from the tertiary packagings prior to the cleaning or inspecting the secondary packagings, and followed by separating the primary packagings from the secondary packagings prior to the cleaning or inspecting of the primary packagings, wherein the primary, secondary, and tertiary packagings are cleaned or inspected separately from one another.

15. The method of claim 13, comprising separating the primary packagings from the secondary packagings prior to the cleaning or inspecting the primary packagings while the secondary packagings are located in the tertiary packagings, and separating the secondary packagings from the tertiary packagings prior to the cleaning or inspecting the secondary packagings, wherein the primary, secondary, and tertiary packagings are cleaned or inspected separately from one another.

16. The method of claim 13, comprising separating the primary packagings from the secondary packagings while the secondary packagings are located in the tertiary packagings, or separating the primary packagings are taken out of the secondary packagings during the removal of the secondary packagings from the tertiary packagings or during the transfer of the secondary packagings to a subsequent cleaning step or inspection step.

17. The method of claim 13 wherein inspecting the primary or the secondary or the tertiary packagings comprises optical checking for existing damages, dirt, color blemishes, other optical blemishes, or for the presence of foreign particles.

18. The method of claim 17, comprising discharging or diverting primary, secondary, or tertiary packagings that have been designated as defective in the inspection step, such discharging or diverting occurring downstream of the inspection.

19. The method of claim 13 comprising refilling the primary packagings after the cleaning or inspecting step, whereupon inserting the primary packagings groupwise into or covered with a cleaned or inspected secondary packaging.

20. The method of claim 19, assembling or inserting at least two secondary packagings, each containing a group of filled primary packagings, into a cleaned or inspected tertiary packaging.

21. The method of claim 13 each tertiary packaging can accommodate at least two different secondary packagings or secondary packagings with different primary packagings located therein.

22. The method of claim 13 comprising drying the primary packagings or the secondary packagings or the tertiary packagings pass after having undergone the cleaning process.

23. The method of claim 13 comprising passing cleaning fluid, used for the cleaning of the primary packagings, through a microfilter, wherein the microfilter retains suspended solids and particles, in particular plastics and filters them out of the cleaning fluid.

24. The method of claim 13 comprising labeling or printing onto the secondary or tertiary packagings after cleaning or inspection has been performed.

25. The method of claim 13 comprising labeling or printing onto the primary packagings after cleaning or inspection has been performed or after refilling.
